(19) United States
(12) Patent Application Publication
(10) Pub. No.: US 2002/0140518 A1
(43) Pub. Date: Oct. 3, 2002

(54) High-frequency diplexer

(76) Inventor: Simon Verghese, Arlington, MA (US)

Correspondence Address: LAW OFFICES OF KURT RAUSCHENBACH, POST OFFICE BOX 387, BEDFORD, MA, 01730, US

(21) Appl. No.: 10/078,785

(22) Filed: Feb. 19, 2002

Related U.S. Application Data
(60) Provisional application No. 60/270,055, filed on Feb. 20, 2001.

(51) Int. Cl. H01P 5/12

(52) U.S. Cl. 333/126

(57) ABSTRACT

A high-frequency diplexer is described. The high-frequency diplexer includes a coupler that receives a fundamental frequency signal and a harmonic frequency signal. The coupler generates a first signal and a second signal. The first signal is substantially ninety degrees-out-of-phase with the second signal. The high-frequency diplexer also includes a phase shifter. The phase shifter generates a relative phase offset between the first and the second signals thereby generating a first and a second phase shifted signal. The high-frequency diplexer also includes a combiner. The combiner receives the phase shifted first and second signals and generates a combined signal at an output of the combiner. The combined signal is a coherent combination of the fundamental frequency signal and the harmonic frequency signal.

### RELATED APPLICATIONS

This patent application claims priority to U.S. provisional patent application Serial No. 60/270,055 that was filed on Feb. 20, 2001, the entire disclosure of which is incorporated herein by reference.

### FIELD OF THE INVENTION

The present invention relates to methods and apparatus for combining high-frequency signals having different operating frequencies and arbitrary amplitudes.

### BACKGROUND OF THE INVENTION

There are known methods and apparatus for combining two high-frequency signals. For example, a device known as a T-junction power combiner is a simple three-port device that can be implemented in waveguide, microstrip or stripline form. T-junction power combiners include two input ports (Z₁ and Z₂) and an output port (Zo). In general, T-junctions are relatively lossless junctions. However, they cannot be impedance matched simultaneously at all ports. If the transmission lines are assumed to be lossless, then the characteristic impedances are real. Thus, an impedance relationship between the ports can be expressed as:

$$\frac{1}{{Z}_{1}} + \frac{1}{{Z}_{2}} = \frac{1}{{Z}_{o}}$$

For example, if each of the two input ports Z₁ and Z₂ has a characteristic impedance of 100Ω (Ohms) and the output port Z₀ has a characteristic impedance of 50Ω, then a 3 dB (equal combine) power combiner can be created.

Another device for combining two high-frequency signals is a resistive combiner. Resistive combiners can be designed to be impedance matched at all ports. Unfortunately, resistive combiners contain lossy components such as lumped-element resistors. An analysis of impedance-matched resistive combiners shows that half of the supplied power is dissipated in the resistors.

One type of resistive combiner is known as a Y-branch frequency diplexer. Y-branch frequency diplexers can be used to combine two high-frequency signals having different frequencies and unequal amplitudes. For example, a Y-branch frequency diplexer can be constructed with dichroic filters placed in each of the input arms of the Y-branch. The filters are used to reflect signals that would otherwise propagate through the input ports.

A Y-branch frequency diplexer can also be constructed with three high-frequency resistors connected in a Y-branch configuration. Y-branch frequency diplexers that are constructed with resistors operate over a broad bandwidth, but such Y-branch diplexers have an undesirable 3 dB combining loss. Additionally, resistive combiners are generally not well suited for higher power applications since the performance of resistive combiners generally degrades with increasing power. This is because a significant amount of the power supplied to the combiner is dissipated in the resistors. Also, Y-branch diplexers generally do not exhibit good isolation between input ports.

Another type of combiner, known as a lossless T-junction combiner, is undesirable because it is not impedance matched at all ports. Also, the lossless T-junction combiner is undesirable because it does not have isolation between ports. Resistive combiners can be impedance matched at all ports. However, resistive combiners do not have adequate isolation between ports.

Another type of combiner, known as a Wilkinson coupler, can be used to efficiently combine two high-frequency signals having the same frequency, the same amplitude, and the same phase with a theoretical loss that is less than 1 dB. However, Wilkinson couplers cannot efficiently combine signals having different frequencies, different amplitudes, and/or different phases.

For example, if each input port of a Wilkinson coupler receives a one-volt signal having the same frequency and the same phase, then a two-volt signal having the same frequency and phase as each of the one-volt signals is observed at the output port. However, if each input port receives a signal having the same amplitude but at different frequencies, the signals will not combine efficiently and some of the signal from one input port can pass out of the other input port or can be dissipated in the shunt resistor.

Thus, there is a need for a high-frequency power combiner having low loss that can be used to combine signals having different frequencies and arbitrary amplitudes.

### SUMMARY OF THE INVENTION

A high-frequency diplexer according to the present invention efficiently combines two high-frequency signals having arbitrary amplitudes and having different frequencies. The frequencies of the two signals are harmonically related. The frequency of the first signal f₁ is related to the frequency of the second signal f₂ through the relationship f₁=(n/m)f₂, where n and m arc odd integers.

Accordingly, in one aspect, the invention is embodied in a diplexer. The diplexer includes a coupler having a first input that receives a fundamental frequency signal and a second input that receives a harmonic frequency signal. The coupler generates a first signal at a first output and a second signal at a second output. The first signal is substantially ninety degrees-out-of-phase with the second signal. In one embodiment, the first signal and the second signal are superpositions of the fundamental frequency signal and the harmonic frequency signal.

In one embodiment, the harmonic frequency signal is a third harmonic of the fundamental signal. In another embodiment, the harmonic frequency signal is a fifth harmonic of the fundamental signal. In still another embodiment, the harmonic frequency signal is a seventh harmonic of the fundamental signal. In one embodiment, a frequency of the fundamental frequency signal is related to a frequency of the harmonic frequency signal by n/m, where n and m are odd integers. In one embodiment, an amplitude of the fundamental frequency signal and an amplitude of the harmonic frequency signal are not equal.

In one embodiment, the coupler is a branch coupler. In one embodiment, the coupler is a microstrip branch coupler. In one embodiment, the coupler includes a first and a second series transmission line and a first and a second parallel shunt transmission line. The first and the second series transmission lines have a characteristic impedance of approximately Z₀/\sqrt{2} at a frequency f₀ where Z₀ is the characteristic impedance of the first and the second parallel shunt transmission lines at a frequency f₀.

The diplexer also includes a phase shifter having a first and a second input that are coupled to the first and the second outputs of the coupler, respectively. The phase shifter generates a relative phase offset between the first and the second signals and generates a first and a second phase shifted signal at a first and a second output of the phase shifter, respectively.

In one embodiment, the phase shifter includes a first and a second series transmission line. In one embodiment, the first series transmission line includes a characteristic impedance of approximately Z₀ at a frequency f₀ and at a length of approximately 5λ₀/16. In one embodiment, the second series transmission line includes a characteristic impedance of approximately Z₀ at a frequency f₀ and at a length of approximately 3λ₀/16.

The diplexer also includes a combiner having a first and a second input that are coupled to the first and the second outputs of the phase shifter, respectively. The combiner receives the phase shifted first and second signals and generates a combined signal at an output of the combiner. The combined signal is a coherent combination of the fundamental frequency signal and the harmonic frequency signal. In one embodiment, the combiner is a Wilkinson-type power combiner. In one embodiment, the combiner includes a power combiner formed of microstrip transmission lines.

In another aspect, the invention is embodied in a method for combining two signals. The method includes generating a first signal and a second signal from a fundamental frequency signal and a harmonic frequency signal. The first signal is substantially ninety degrees out-of-phase with the second signal.

In one embodiment, the harmonic frequency signal is substantially a third harmonic of the fundamental frequency signal. In another embodiment, the harmonic frequency signal is substantially a seventh harmonic of the fundamental frequency signal. In one embodiment, a frequency of the fundamental frequency signal is related to a frequency of the harmonic frequency signal by n/m, where n and m are odd integers. In one embodiment, an amplitude of the fundamental frequency signal and an amplitude of the harmonic frequency signal are not equal.

The method also includes generating a relative phase offset between the first and the second signals. In one embodiment, the relative phase offset between the first and the second signals substantially phase match the first and the second signals. The method further includes combining the first and the second signals to generate an output signal. The output signal is a coherent combination of the fundamental frequency signal and the harmonic frequency signal.

### BRIEF DESCRIPTION OF THE DRAWINGS

This invention is described with particularity in the detailed description. The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates an ideal transmission line model of a high-frequency diplexer according to the present invention.

FIG. 2 illustrates a microstrip transmission line geometry of the high-frequency diplexer that is described in connection with FIG. 1.

FIG. 3 is a graph of calculated transmission and reflection data for the high-frequency diplexer described in connection with FIGS. 1 and 2.

FIG. 4 is a graph of measured transmission data for the high-frequency diplexer described in connection with FIGS. 1 and 2.

### DETAILED DESCRIPTION

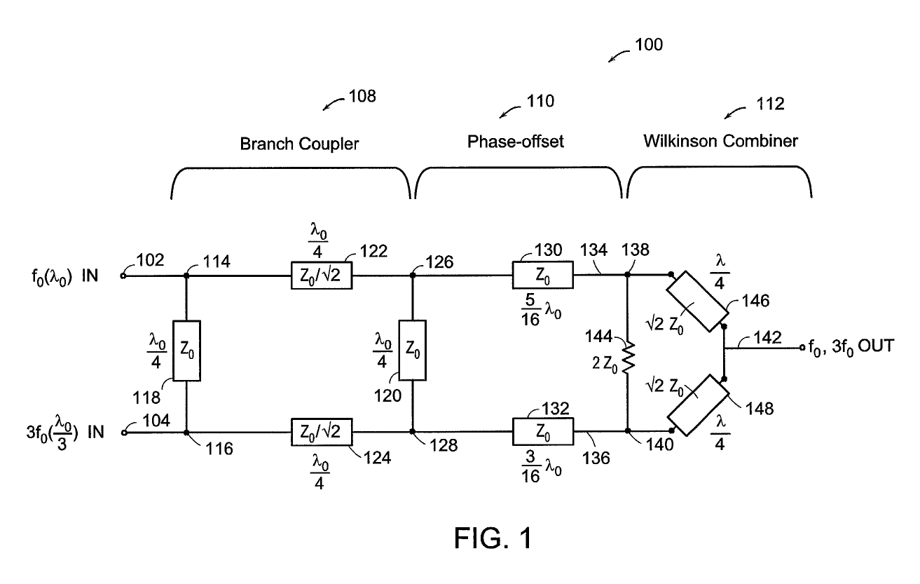

FIG. 1 illustrates an ideal transmission line model of a high frequency diplexer 100 according to the present invention. The diplexer 100 has a feed-forward configuration that coherently combines a fundamental input signal (shown as f₀) with an odd harmonic of the fundamental input signal (shown as 3f₀). The diplexer 100 includes a fundamental signal input port 102 and a harmonic signal input port 104. In one embodiment, the fundamental 102 and the harmonic signal input ports 104 are terminated with characteristic output impedances of Z₀.

The diplexer 100 includes a branch coupler 108, a phase offset section 110, and a Wilkinson combiner 112. The branch coupler 108 has a first 114 and a second input port 116 that is coupled to the fundamental 102 and the harmonic signal input ports 104, respectively. The branch coupler 108 includes a parallel input transmission line 118 and a parallel output transmission line 120. The parallel input transmission line 118 and the parallel output transmission line 120 are sometimes referred to as parallel shunt transmission lines. The parallel input transmission line 118 and the parallel output transmission line 120 are λ₀/4 in length, where λ₀ is the electrical wavelength corresponding to the frequency f₀ in the embodiment shown in FIG. 1.

The branch coupler 108 also includes a first series transmission line 122 that is connected in series with the first input port 114 of the branch coupler 108 and the fundamental signal input port 102. The branch coupler 108 also includes a second series transmission line 124 that is connected in series with the second input port 116 of the branch coupler 108 and the harmonic signal input port 104. For the diplexer 100 illustrated in FIG. 1, each of the first 122 and the second series transmission lines 124 has characteristic impedance, Z₀/\sqrt{2} at the frequency f₀. The branch coupler 108 includes a first 126 and a second output port 128 that generate a first and a second signal. The first and the second signals are superpositions of the fundamental and the harmonic signal. In one embodiment, the first and the second signals are ninety degrees out-of-phase.

The branch coupler 108 is sometimes referred to as a quadrature (90°) hybrid. Quadrature hybrids are 3 dB directional couplers having a ninety degree (90°) phase difference between the first 126 and the second output ports 128. In one embodiment, this type of hybrid can be fabricated in microstrip or stripline form. In this embodiment, the hybrid is also known as a branch-line hybrid.

Scattering matrixes are often used to describe N-port high-frequency networks, such as a quadrature hybrid network. A scattering matrix represents incident, reflected, and transmitted waves as seen at each of the N ports of the high-frequency network. The scattering matrix contains so-called scattering parameters or S-parameters.

A quadrature hybrid, such as the branch coupler 108, is a coupler having a coupling factor of 3 dB between the first input port 114 and the two output ports 126, 128. The quadrature hybrid includes four (4) ports and has a ninety degree (90°) phase shift (φ=π/2) between its output ports 126, 128 when a signal is coupled into the first input port 114. The first 114 and the second input ports 116 are substantially isolated from each other. The quadrature hybrid is a symmetrical coupler having an [S] matrix as follows:

$$[ S ] = [ \begin{matrix}{S}_{11} & {S}_{12} & {S}_{13} & {S}_{14} \\ {S}_{21} & {S}_{22} & {S}_{23} & {S}_{24} \\ {S}_{31} & {S}_{32} & {S}_{33} & {S}_{34} \\ {S}_{41} & {S}_{42} & {S}_{43} & {S}_{44}\end{matrix} ] = \frac{- 1}{\sqrt{2}} [ \begin{matrix}0 & j & 1 & 0 \\ j & 0 & 0 & 1 \\ 1 & 0 & 0 & j \\ 0 & 1 & j & 0\end{matrix} ]$$

where the subscripts [1], [2], [3], and [4] represent the first input port 114, the first output port 126, the second output port 128, and the second input port 116, respectively.

Note that coefficients |S₁₁|²=|S₄₄|²=0 represent the reflection coefficients seen at the first 114 and the second input ports 116. Thus, for an ideal quadrature hybrid coupler, no power is reflected back to the input ports 114 , 116 or coupled between the input ports 114 , 116. Instead, the total input power is transmitted to the first 126 and the second output ports 128 with no loss in power. Additionally, S₂₁ represents the transmission coefficient seen at the first output port 126 from the first input port 114 (i.e., S₂₁=−j/\sqrt{2}) and S31 represents the transmission coefficient seen at the second output port 128 from the first input port 114 (i.e., S₃₁=−1/\sqrt{2}). Thus, in an ideal coupler, one-half of the power applied to the first input port 114 is transmitted to each of the first output port 126 and the second output port 128 (i.e., |S₂₁|²=|S₃₁|²=½). Similarly, one-half of the power applied to the second input port 116 is transmitted to each of the first output port 126 and the second output port 128 (i.e., |S₂₄|²=|S₃₄|²=½).

The phase of the fundamental input signal is shifted by 90° from the first input port 114 to the first output port 126. In addition, the phase of the fundamental input signal is shifted by 180° from the first input port 114 to the second output port 128. Similarly, the phase of the harmonic input signal is shifted by 180° from the second input port 116 to the first output port 126. The phase of the harmonic input signal is shifted by 90° from the second input port 116 to the second output port 128.

In one example, for a fundamental frequency f₀, it can be shown that in order to design a 50Ω (Ohm) quadrature hybrid, each of the first 122 and the second series transmissions lines 124 should have branch-line impedances of:

$$\frac{{Z}_{0}}{\sqrt{2}} = \frac{50}{\sqrt{2}} = 35.36 Ω$$

In one embodiment, the branch coupler 108 generates a superposition of the f₀ and the 3f₀ signals at the first 126 and the second output ports 128. In one embodiment, the fundamental and the harmonic signals at the first 126 and the second output ports 128, respectively, are 90° out-of-phase relative to each other.

The phase-offset section or phase shifter 110 includes a first 130 and a second series transmission line 132 that are coupled to the first 126 and the second output ports 128 of the branch coupler 108, respectively. The phase shifter 110 generates a first and a second signal at a first 134 and a second output 136, respectively. The first and the second signals have the desired relative phase-offset that enables the fundamental signal and the harmonic signal to be coherently combined by the Wilkinson combiner 112.

In the embodiment illustrated in FIG. 1, the first series transmission line 130 has characteristic impedance, Z₀, at a frequency f₀, and is 5λ₀/16 in length. The second series transmission line 132 has characteristic impedance, Z₀, at a frequency f₀, and is 3₀/16 in length. These characteristic impedances and lengths are chosen to generate a desired phase offset between the first and the second signals generated at the first 134 and the second outputs 136, respectively, of the phase shifter 110. The desired phase-offset is a relative phase difference between the first and the second signals that enables the fundamental signal f₀ and the third harmonic signal 3f₀ to be coherently combined in the Wilkinson combiner 112 at relatively high efficiency.

In one example, for a fundamental frequency f₀ of 10 GHz, it can be shown that the phase of a signal in the first series transmission line 130 having characteristic impedance of 50Ω should be shifted by 112.5° and the phase of a signal in the second series transmission line having characteristic impedance of 50Ω should be shifted by 67.5°.

The Wilkinson combiner 112 is a three port power combining device that combines two high-frequency signals. The Wilkinson combiner 112 includes a first 138 and a second input port 140 and an output port 142. The first 138 and the second input ports 140 of the Wilkinson combiner 112 are coupled to the first 134 and the second outputs 136 of the phase shifter 110 respectively. The Wilkinson combiner 112 also includes a resistor 144 having impedance of 2Z₀. The resistor 144 is coupled between the first 138 and the second input ports 140. The resister 144 is sometimes referred to as a shunt resistor.

The Wilkinson combiner 112 also includes a first transmission line 146 and a second transmission line 148 The first transmission line 146 is coupled between the first input port 138 and the output port 142. The second transmission line 148 is coupled between the second input port 140 and the output port 142. Each of the first 146 and the second transmission lines 148 has a characteristic impedance, \sqrt{2}Z₀, at a frequency f₀, and is λ₀/4 in length, where Z₀ is the characteristic impedance of the first 118 and the second parallel shunt transmission lines 120 at a frequency f₀.

The Wilkinson combiner 112 can be constructed so that all ports are impedance matched. Also, the Wilkinson combiner 112 can be constructed so that the first 138 and the second input ports 140 are isolated. In addition, the Wilkinson combiner 112 can exhibit substantially lossless operation when the first 138 and the second input ports 140 are impedance matched.

A scattering matrix is often used to describe the Wilkinson combiner. The scattering matrix represents incident, reflected, and transmitted waves as seen at each of the three ports 138, 140, and 142 of the Wilkinson combiner 112. The Wilkinson combiner 112 includes a 90° phase shift (φ=π/2) between the first input port 138 and the output port 142 when a signal is coupled into the first input port 138. Since the Wilkinson combiner 112 is symmetrical, it also includes a 90° phase shift (φ=π/2) between the second input port 140 and the output port 142 when a signal is coupled into the second input port 140. The first 138 and the second input ports 140 are substantially isolated from each other.

Wilkinson combiners can be used to efficiently combine a first signal and a second signal as long as the first and the second signals have substantially identical frequency, amplitude, and phase. The Wilkinson combiner cannot efficiently combine two signals that are not identical. Some of the power will be lost or dissipated in the shunt resistor when the first and the second signals are not identical.

Assuming that the first input port 138 and the second input port 140 of the Wilkinson combiner 112 are excited with signals having the frequency, amplitude, and phase, the so-called symmetric mode Wilkinson combiner has the following [S] matrix:

$$[ S ] = [ \begin{matrix}{S}_{11} & {S}_{12} & {S}_{13} \\ {S}_{21} & {S}_{22} & {S}_{23} \\ {S}_{31} & {S}_{32} & {S}_{33}\end{matrix} ] = [ \begin{matrix}0 & 0 & 1 \\ 0 & 0 & 1 \\ 1 & 1 & 0\end{matrix} ]$$

where the subscripts [1], [2], and [3], represent the first input port 138, the second input port 140, and the output port 142, respectively.

The coefficients |S₁₁|²=S₂₂|²=0 represent matched impedance input ports 138, 140. Additionally, the coefficients S₃₁=S₃₂=1 represent the transmission coefficients seen at the output port 142 from each of the first 138 and the second input ports 140. Thus, for an ideal Wilkinson combiner, no power is reflected back to the input ports 138, 140 or coupled between the input ports 138, 140. Instead, the total input power from each of the first 138 and the second input ports 140 is transmitted to the output port 142 with no loss in power.

In one example, for a fundamental frequency f₀, it can be shown that in order to design a Wilkinson combiner for a 50Ω (Ohm) system impedance, each of the first 146 and second series transmissions lines 148 should have branch-line impedances of:

\sqrt{2}Z₀=\sqrt{2}(50)=70.7Ω

and the shunt resistor should have a value of R=2Z₀=100Ω.

The high frequency diplexer 100 is a passive component that efficiently combines the power of two high-frequency signals having arbitrary amplitude and having frequencies f₁ and f₂ subject to the constraint f1=(n/m)f₂, where n and m are odd integers. The diplexer 100 illustrated in the transmission line model of FIG. 1 has a simulated combining loss of less than 1 dB and a port isolation of greater than 70 dB.

Numerous other embodiments of the high frequency diplexer of the present invention are possible. In one embodiment, the high frequency diplexer is designed to combine higher-order odd harmonics. In this embodiment, the first 130 and the second series transmission lines 132 in the phase shifter 110 are designed to generate the desired phase offset so that the fundamental signal and the harmonic signal are coherently combined with the Wilkinson combiner 112 at high efficiency. In addition, the diplexer 100 can be constructed with any type of transmission lines having the appropriate frequency response. For example, the diplexer 100 can be constructed using microstrip transmission lines.

In operation, a signal having a fundamental frequency f₀ is coupled into the first input port 102. For example, the fundamental frequency f₀ can be 10 GHz. A signal having a frequency that is a third harmonic of the fundamental frequency (3f₀) or 30 GHz is coupled to the second input port 104 .The fundamental frequency signal and the third harmonic frequency signal propagate into the branch coupler 108. The branch coupler 108 generates a first and a second signal that are each superpositions of the 10 GHz and 30 GHz signals at the first 126 and the second output ports 128, respectively. The first and second signals are ninety degrees out-of-phase relative to each other.

The phase shifter 110 introduces a phase shift to the first and the second signals that substantially phase-match the first and the second signals. In one embodiment, the first series transmission line 130 is 5λ₀/16 in length. The second series transmission line 132 is 3λ₀/16 in length. This difference in length provides the desired phase offset in order to phase-match the first and the second signals. The phase-matched first and second signals are coupled to the first 138 and the second input ports 140 of the Wilkinson combiner 112 The Wilkinson combiner 112 combines the phase-matched first and second signals to generate a combined signal at the output 142. The combined signal is a coherent combination of the fundamental and the harmonic frequency signals.

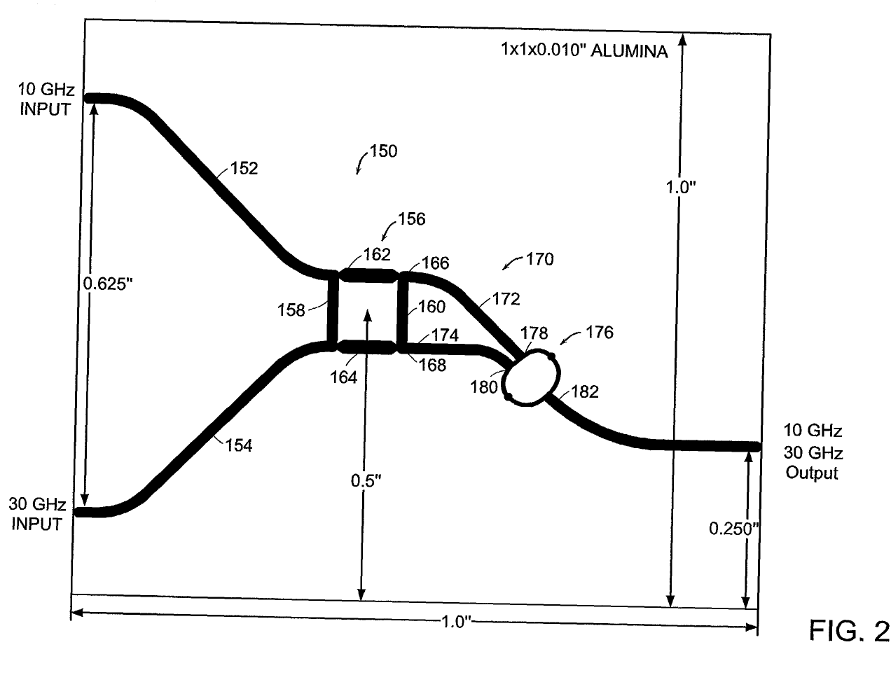

FIG. 2 illustrates a 50Ω microstrip transmission line geometry 150 of the high-frequency diplexer 100 that is described in connection with FIG. 1. The geometry of the structure illustrated in FIG. 2 is chosen for efficiently combining an approximately 10 GHz fundamental and an approximately 30 GHz (third harmonic) signal. In another embodiment, for example, the invention can be used to combine a 30 GHz fundamental and a 90 GHz signal. Commercially available design simulators can be used to select the geometry for the structure. The geometry 150 illustrated in FIG. 2 is approximately drawn to scale.

The transmission lines and resistors in the Wilkinson combiner can be fabricated on numerous types of substrates. For example, the transmission lines and resistors can be fabricated on an alumina substrate. Also, the transmission lines and resistors in the Wilkinson combiner can be fabricated with numerous types of metal films. For example, the resistors can be TaN thin film resistors having a resistivity of approximately 50Ω per square inch. The transmission lines can be formed of Ti/W/Au thin film resistors having a thickness of approximately 150μ-inches (micro-inches).

The diplexer 100 transmission line geometry 150 includes a first 152 and a second input transmission line 154 that receive the fundamental and the harmonic signals, respectively. The transmission line structure 150 includes a mircostrip branch coupler 156 that is rectangular in shape. The branch coupler 156 includes a parallel input transmission line 158 and a parallel output transmission line 160. The branch coupler 156 also includes a first series transmission line 162 that is connected in series with the first input transmission line 152 and a second series transmission line 164 that is connected in series with the second input transmission line 154. The branch coupler 156 has a first 166 and a second output port 168 that generates a first and a second signal. The first and the second signals are superpositions of the fundamental and the harmonic signal and are ninety degrees out-of-phase relative to each other.

The diplexer transmission line structure 150 also includes a microstrip phase-offset section 170 that includes a first 172 and a second series transmission line 174 that are coupled to the first 166 and the second outputs 168 of the branch coupler 156 respectively. The phase-offset section 170 generates the desired phase offset between two signals generated by the first 166 and the second outputs 168 of the branch coupler 156 so that the fundamental signal and the harmonic signal can be coherently combined with the Wilkinson combiner.

The diplexer transmission line structure 150 also includes a microstrip Wilkinson combiner 176 that is oval shaped. The microstrip Wilkinson combiner 176 is a three port device that coherently combines the fundamental and the harmonic signals. The first 178 and the second input ports 180 of the microstrip Wilkinson combiner 176 are coupled to the first 172 and the second series transmission lines 174 of the phase-offset section 170, respectively. An output port 182 of the Wilkinson combiner 176 produces a signal that is a coherent combination of the fundamental and the harmonic signals.

In one embodiment, the diplexer transmission line structure 150 also can include a microstrip DC bias tee (not shown) that provides a DC bias voltage to the structure 150. A DC voltage input (not shown) provides the DC bias voltage to the DC bias tee.

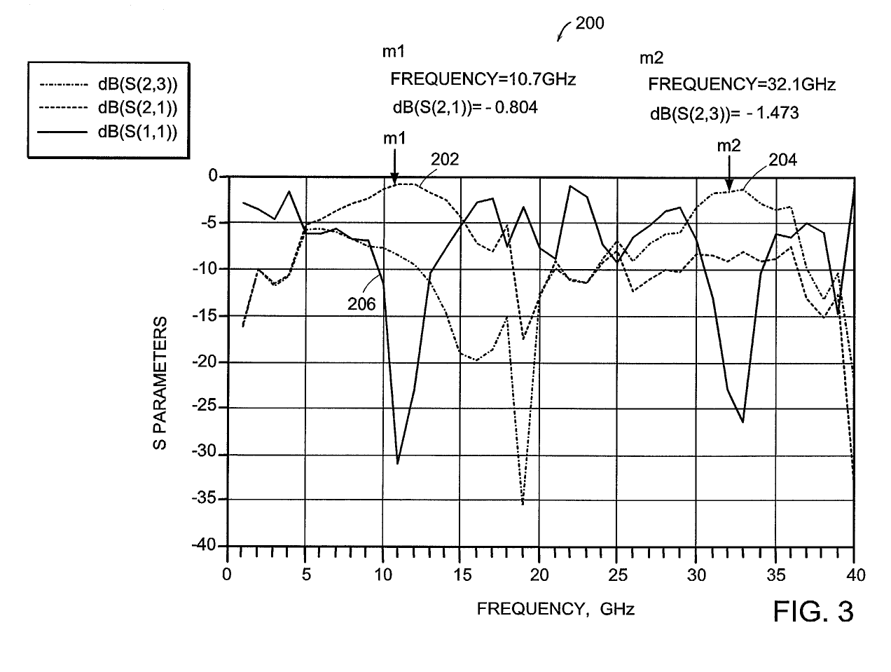

FIG. 3 is a graph 200 of calculated transmission and reflection data for the high-frequency diplexer 100 described in connection with FIGS. 1 and 2. Calculated data is shown for the fundamental signal transmission and the harmonic signal transmission. Specifically, the graph 200 illustrates calculated data 202 for the fundamental transmission coefficient S₂₁. The transmission coefficient S₂₁ represents the transmission of a signal from the fundamental signal input port 102 (FIG. 1) to the output 142 (FIG. 1) of the Wilkinson combiner 112 (FIG. 1). The data illustrates that at a fundamental frequency f₀ of approximately 11 GHz, substantially all of the energy coupled to the fundamental signal input port 102 is present at the output 142 of the Wilkinson combiner 112

The graph 200 also illustrates calculated data 204 for the harmonic signal transmission coefficient S₂. The transmission coefficient S₂₁ represents the transmission of a signal from the harmonic signal input port 104 (FIG. 1) to the output 142 (FIG. 1) of the Wilkinson combiner 112 (FIG. 1). The data illustrates that at a harmonic frequency 3f₀ of approximately 32 GHz, substantially all of the energy coupled to the harmonic signal input port 104 is also present at the output 142 of the Wilkinson combiner 112

In addition, the graph 200 illustrates calculated data 206 for the reflection coefficient S₁₁ at the fundamental signal input port 102 (FIG. 1). The reflection coefficient S₁₁ represents power reflected back to the input port 102 (FIG. 1) from the output 142 (FIG. 1) of the Wilkinson combiner 112 (FIG. 1). The data illustrates that at a fundamental frequency f₀ of approximately 11 GHz, substantially less than one percent of the energy at the output 142 of the Wilkinson combiner 112 is reflected back or coupled to the fundamental signal input port 102.

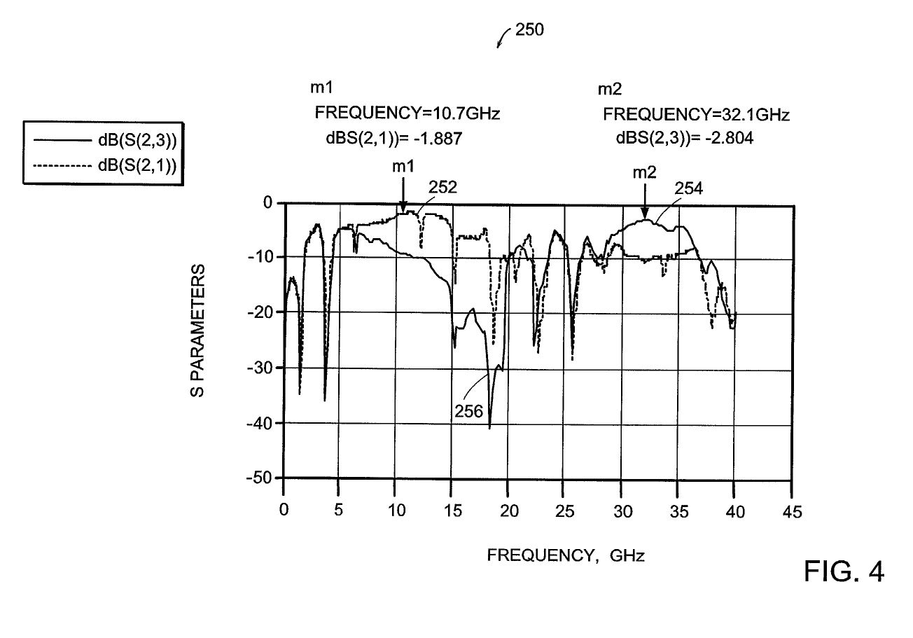

FIG. 4 is a graph 250 of measured transmission data for the high-frequency diplexer described in connection with FIGS. 1 and 2. Measured data is shown for the fundamental signal transmission and the harmonic signal transmission. Specifically, the graph 250 illustrates measured data 252 for the fundamental transmission coefficient S₂₁, which is the transmission of a signal from the fundamental signal input port 102 (FIG. 1) to the output 142 (FIG. 1) of the Wilkinson combiner 112 (FIG. 1).

The graph 250 also illustrates measured data 254 for the harmonic signal transmission coefficient S₂₃, which is the transmission of a signal from the harmonic signal input port 104 (FIG. 1) to the output 142 (FIG. 1) of the Wilkinson combiner 112 (FIG. 1). As expected, the measured data 256 for the harmonic signal transmission coefficient S₂₃ exhibits higher loss as the frequency departs from the harmonic frequency.

The graph 200 (FIG. 3) of calculated transmission and reflection data for the high-frequency diplexer 100 approximately corresponds to the graph 250 (FIG. 4) of measured transmission data for the high-frequency diplexer 100. The measured data, however, illustrates more loss, which is due, at least in part, to losses associated with the connectors. The measured data also illustrates sharp features, which are caused by resonances associated with the package.

The graph 200 (FIG. 3) of calculated and the graph 250 (FIG. 4) of measured transmission and reflection data for the high-frequency diplexer 100 indicate that the high frequency diplexer 100 of FIGS. 1 and 2 can efficiently combine a 10 GHz fundamental signal and a 30 GHz 3rd harmonic signal. The diplexer 100 can efficiently combine a fundamental signal and a harmonic of the fundamental signal with arbitrary fundamental and harmonic signal amplitudes. The frequency of the first source f₁, is related to the frequency of the second source f₂ through the relationship f₁=(n/m)f₂, where n and m are odd integers.

The phase response of the high-frequency diplexer of the present invention is more linear compared to known diplexers constructed from combinations of filters, such as bandstop and bandpass filters. In addition, the high-frequency diplexer of the present invention is relatively simple to construct and, therefore is relatively inexpensive because it does not require complex components such as resonant filters.

The high-frequency diplexer of the present invention has particular advantages over the use of an isolated Wilkinson combiner. One such advantage is that the high-frequency diplexer of the present invention can efficiently combine two high-frequency signals having unequal amplitudes.

Also, the high-frequency diplexer of the present invention has particular advantages compared with Y-branch frequency diplexers. One advantage is that the high-frequency diplexer of the present invention has a combining loss of less than 1 dB. Another advantage is that the high-frequency diplexer of the present invention uses a feed-forward configuration that can be implemented without complicated filter structures and without significant group-delay dispersion, which is typically exhibited by frequency diplexers operating near the edges of their passbands.

One application of the high frequency diplexer of the present invention is to generate a nonlinear waveform that has relatively sharp rising and falling edges compared with a fundamental sinusoidal oscillation. Such a waveform can be created by combining a fundamental signal with a portion of a higher harmonic of the fundamental signal, such as the 3rd harmonic of the fundamental signal. More complex waveforms can be generated by combining higher harmonics and multiple higher harmonics of the fundamental waveform.

There are numerous applications for these non-linear waveforms. One application for these waveforms is modulating electro-optic modulators and clocking high-speed digital circuits. For example, the high-frequency diplexer of the present invention can be used to generate non-sinusoidal RF waveforms that can be used to drive an optical modulator to generate optical pulses that are useful for long distance communications.

For example, the high-frequency diplexer of the present invention can be used with an optical pulse generator, such as the type described in U.S. patent application, attorney docket number PHOL-113, entitled “Tunable Pulse Width Optical Pulse Generator,” filed on Feb. 19, 2002, and which is assigned to the current assignee. The entire disclosure of this U.S. patent application is incorporated herein by reference.

These non-linear waveforms can also be used to drive switching-mode RF amplifiers that have high power-added efficiencies. RF switching-mode amplifiers are used as power amplifiers in numerous devices, such as cell phones and radio transmitters. These amplifiers offer much higher efficiency than conventional linear amplifiers. The high-frequency diplexer of the present invention is particularly advantageous for driving switching-mode RF amplifiers because the diplexer can combine a fundamental signal and a harmonic of the fundamental signal with relatively low loss. Thus, the high-frequency diplexer of the present invention can efficiently create a suitable non-linear waveform for driving power amplifiers, such as Class D, E, F, and S power amplifiers.

### EQUIVALENTS

While the invention has been particularly shown and described with reference to specific preferred embodiments, it should be understood by those skilled in the art that various changes in form and detail may be made therein without departing from the spirit and scope of the invention as defined herein.

What is claimed is:

1. A diplexer comprising:
a) a coupler having a first input that receives a fundamental frequency signal and a second input that receives a harmonic frequency signal, the coupler generating a first signal at a first output and a second signal at a second output, the first signal being substantially ninety degrees-out-of-phase with the second signal;
b) a phase shifter having a first and a second input that are coupled to the first and the second output of the coupler, respectively, the phase shifter generating a relative phase offset between the first and the second signals and generating a first and a second phase shifted signal at a first and a second output of the phase shifter, respectively; and
c) a combiner having a first and a second input that are coupled to the first and the second output of the phase shifter, respectively, the combiner receiving the phase shifted first and second signals and generating a combined signal at an output of the combiner, the combined signal being a coherent combination of the fundamental frequency signal and the harmonic frequency signal.

2. The diplexer of claim 1 wherein the first signal and the second signal are superpositions of the fundamental frequency signal and the harmonic frequency signal.

3. The diplexer of claim 1 wherein the coupler comprises a branch coupler.

4. The diplexer of claim 1 wherein the coupler comprises a microstrip branch coupler.

5. The diplexer of claim 1 wherein the coupler comprises a first and a second series transmission line and a first and a second parallel shunt transmission line.

6. The diplexer of claim 5 wherein the first and the second parallel shunt transmission lines comprise a characteristic impedance of Z₀ at a frequency f₀ and the first and the second series transmission lines comprise a characteristic impedance of approximately Z₀/\sqrt{2} at a frequency f₀.

7. The diplexer of claim 1 wherein the combiner comprises a Wilkinson-type power combiner.

8. The diplexer of claim 1 wherein the combiner comprises a power combiner formed of microstrip transmission line.

9. The diplexer of claim 1 wherein the phase shifter comprises a first and a second series transmission line.

10. The diplexer of claim 9 wherein the first series transmission line comprises a characteristic impedance of approximately Z₀ at a frequency f₀ and at a length of approximately 5λ₀/16.

11. The diplexer of claim 9 wherein the second series transmission line comprises a characteristic impedance of approximately Z₀ at a frequency f₀ and at a length of approximately 3λ₀/16.

12. The diplexer of claim 1 wherein the first and the second phase shifted signals are substantially phased matched to each other.

13. The diplexer of claim 1 wherein the harmonic frequency signal comprises a third harmonic of the fundamental signal.

14. The diplexer of claim 1 wherein the harmonic frequency signal comprises a fifth harmonic of the fundamental signal.

15. The diplexer of claim 1 wherein the harmonic frequency signal comprises a seventh harmonic of the fundamental signal.

16. The diplexer of claim 1 wherein a frequency of the fundamental frequency signal is related to a frequency of the harmonic frequency signal by n/m, where n and m are odd integers.

17. The diplexer of claim 1 wherein an amplitude of the fundamental frequency signal and an amplitude of the harmonic frequency signal are not equal.

18. A method for combining two signals, the method comprising:
a) generating a first signal and a second signal from a fundamental frequency signal and a harmonic frequency signal, the first signal being substantially ninety degrees out-of-phase with the second signal;
b) generating a relative phase offset between the first and the second signals; and
c) combining the first and the second signals to generate an output signal, the output signal being a coherent combination of the fundamental frequency signal and the harmonic frequency signal.

19. The method of claim 18 wherein the harmonic frequency signal is substantially a third harmonic of the fundamental frequency signal.

20. The method of claim 18 wherein the harmonic frequency signal is substantially a fifth harmonic of the fundamental frequency signal.

21. The method of claim 18 wherein the harmonic frequency signal is substantially a seventh harmonic of the fundamental frequency signal.

22. The method of claim 18 wherein a frequency of the fundamental frequency signal is related to a frequency of the harmonic frequency signal by n/m, where n and m are odd integers.

23. The method of claim 18 wherein an amplitude of the fundamental frequency signal and an amplitude of the harmonic frequency signal are not equal.

24. The method of claim 18 wherein the relative phase offset between the first and the second signals substantially phase match the first and the second signals.

25. A high-frequency diplexer comprising:
a) means for generating a first signal and a second signal from a fundamental frequency signal and a harmonic frequency signal, the first signal being substantially ninety degrees out-of-phase with the second signal;
b) means for generating a relative phase offset between the first and the second signals; and
c) means for combining the first and the second signals to generate an output signal, the output signal being a coherent combination of the fundamental frequency signal and the harmonic frequency signal.
